(19) United States
(12) Patent Application Publication
(10) Pub. No.: US 2026/0254398 A1
(43) Pub. Date: Aug. 27, 2026

(54) SUPPORT STRUCTURES FOR SOLAR TRACKER SYSTEMS WITH INCREASED TOLERANCE

(71) Applicant: Nextpower LLC, Fremont, CA (US)

(72) Inventors: Abhimanyu Anil Sable, Fremont, CA (US); Charles Almy, Berkeley, CA (US)

(21) Appl. No.: 19/540,986

(22) Filed: Feb. 16, 2026

Related U.S. Application Data
(60) Provisional application No. 63/762,320, filed on Feb. 24, 2025.

(51) Int. Cl. H02S 20/10; E04C 3/04; F24S 25/10; F24S 25/13

(52) U.S. Cl. CPC H02S 20/10; F24S 25/10; F24S 25/13; E04C 2003/0491

(57) ABSTRACT

A truss foundation includes a pair of truss legs, each leg including an elongated anchor having a top end portion and a bottom end portion, and an elongated upper leg comprising a first leg portion and a second leg portion. The first leg portion includes a first planar side, and the second leg portion includes a second planar side, the first planar side positioned adjacent the second planar side and defining a gap therebetween. The first leg portion and the second leg portion each configured to couple with the top end portion of the elongated anchor at a second end portion of the elongated upper leg. The truss foundation may further include an adapter having a pair of connecting surfaces projecting away from the main body, the adapter configured to couple with a first end portion of each of the elongated upper legs to form an A-frame shaped truss structure.

### RELATED APPLICATIONS

This application claims the benefit of U.S. Provisional Patent Application No. 63/762,320, filed Feb. 24, 2025, the entire contents of which are incorporated herein by reference.

### TECHNICAL FIELD

This disclosure relates generally to solar power generation systems, and more particularly, to support structures for solar arrays within a solar tracking system.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Solar tracking systems can be used to dynamically orient a plurality of solar modules, for instance, by moving the solar modules throughout the course of a given day to track the movement of the sun and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules. The present disclosure seeks to address the shortcomings of prior tracker systems.

### SUMMARY

In general, the present disclosure relates to support structures for solar arrays within a solar tracking system. In one example, a truss foundation may include a pair of truss legs. Each truss leg may include an elongated anchor having a top end portion and a bottom end portion opposite the top end portion, and an elongated upper leg comprising a first leg portion and a second leg portion, the first leg portion having a first planar side and the second leg portion having a second planar side, the first planar side positioned adjacent the second planar side and defining a gap therebetween, the first leg portion and the second leg portion configured to couple with the top end portion of the elongated anchor at a second end portion of the elongated upper leg. The truss foundation may further include an adapter having a main body and a pair of connecting surfaces projecting away from the main body and spaced apart by an angle in a range of more than 35-degrees up to and including 70-degrees, the adapter configured to couple with a first end portion of each of the elongated upper legs to form an A-frame shaped truss structure.

Additionally or alternatively, the first leg portion and the second leg portion may be roll formed to include a generally C-shaped profile.

Additionally or alternatively, the top end portion of the elongated anchor may include a connecting surface, and the top end portion of the elongated anchor is joined to the second end portion of the elongated upper leg by positioning the connecting surface within the gap formed between the first leg portion and the second leg portion.

Additionally or alternatively, the elongated anchor may be formed from one of an I-beam or a box beam.

Additionally or alternatively, each truss leg may further include a connector bracket configured to join the top end portion of the elongated anchor to the second end portion of the elongated upper leg.

Additionally or alternatively, joining the top end portion of the elongated anchor and the second end portion of the elongated upper leg via the connector bracket may form a slip critical connection.

Additionally or alternatively, the connector brackets may be configured to hold the elongated upper legs at angles such that the first end portion of one of the elongated upper legs extends in a direction towards the other first end portion of the elongated upper legs, and the connector bracket is further configured to hold each respective elongated anchor plumb.

Additionally or alternatively, the connector brackets may each include an upper portion, a middle portion, and a lower portion, the lower portion including a first arm and a second arm opposite the first arm, the first arm and the second arm defining one or more holes configured to align with one or more holes defined by the elongated anchor.

Additionally or alternatively, the middle portion may include a first ledge region and a second, opposing ledge region, the first ledge region configured to engage with the first leg portion and the second ledge region configured to engage with the second leg portion at the second end portion of each elongated upper leg.

Additionally or alternatively, the upper portion of each connector bracket may include a planar surface defining one or more holes, and the first leg portion and the second leg portion of each elongated upper leg define one or more holes proximate the second end portion of the elongated upper leg, and the one or more holes defined by the upper portion configured to align with the one or more holes defined by the second end portion of each of the elongated upper legs.

Additionally or alternatively, the planar surface of the upper portion of the connector bracket may be configured to be positioned within the gap between the first leg portion and the second leg portion at the second end portion of each elongated upper leg.

Additionally or alternatively, when the elongated anchor and the elongated upper leg of each truss leg are joined together at the top end portion of the elongated anchor and the second end portion of the elongated upper leg, the elongated anchor and the elongated upper leg define a substantially common axis.

Additionally or alternatively, the joining together of the top end portion of the elongated anchor and the second end portion of the elongated upper leg of each truss leg may form a slip critical connection.

In another example, a truss structure may include a pair of truss legs. Each truss leg may include an anchor having a top end and a bottom end, a first leg portion and a second leg portion couplable to the top end of the anchor at a second end of the first leg portion and the second leg portion, the first leg portion having a first planar side and the second leg portion having a second planar side, the first planar side positioned adjacent the second planar side and defining a gap therebetween. The truss structure may further include an adapter configured to couple with each truss leg to form a shaped truss structure, the adapter configured to couple with the first leg portion and the second leg portion at a first end of the first leg portion and the second leg portion of each truss leg.

Additionally or alternatively, the first leg portion and the second leg portion may be roll formed to include a generally C-shaped profile.

Additionally or alternatively, for each truss leg, the top end of the anchor may include a connecting surface to which the first leg portion and the second leg portion couple, the connecting surface positioned in the gap between the first planar side and the second planar side when the first leg portion and the second leg portion are coupled to the anchor.

Additionally or alternatively, for each truss leg, the connecting surface may define one or more holes, and the first leg portion and the second leg portion each define one or more holes at the second end, the one or more holes of the connecting surface configured to align with the one or more holes of each of the first leg portion and the second leg portion.

Additionally or alternatively, each truss leg may include a connector bracket, the connector bracket of each truss leg configured to couple the top end of the anchor with the first leg portion and the second leg portion.

Additionally or alternatively, the connector bracket of each truss leg may include a lower portion and an upper portion, the lower portion including a first arm and a second arm configured to couple to a first side and a second side of the anchor at the top end, the upper portion including a planar surface to which the first leg portion and the second leg portion couple.

Additionally or alternatively, the planar surface may define one or more holes, and the first leg portion and the second leg portion each define one or more holes, the one or more holes of the planar surface configured to align with the one or more holes of the first leg portion and the second leg portion when the planar surface is positioned within the gap defined by the first leg portion and the second leg portion.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a schematic, perspective view of a solar tracker truss foundation embedded in a ground;

FIG. 4 is a front-side view of the solar tracker truss foundation, as in FIG. 3;

FIG. 5 is a side view of the solar tracker truss foundation, as in FIG. 3;

FIG. 6A is a side view of an upper leg of the solar tracker truss foundation, as in FIG. 4;

FIG. 6B is a top-down perspective view of the upper leg of the solar tracker truss foundation, as in FIG. 6A;

FIG. 6C is a perspective view of the upper leg of the solar tracker truss foundation, as in FIG. 6A;

FIG. 7A is a front-side view of the solar tracker truss foundation, as in FIG. 3, with a first portion of a first upper leg removed;

FIG. 7B is an enlarged view of an upper portion of the solar tracker truss foundation with the first portion of the first upper leg removed, as in FIG. 7A;

FIG. 8A is an enlarged view of a lower connecting portion, as in Circle 8A of FIG. 7B;

FIG. 8B is an enlarged view of an underside view of an upper connecting portion, as in Circle 8B of FIG. 7B;

FIG. 9A is a front-side view of an example truss adapter in accordance with the disclosure;

FIG. 9B is a side-perspective view of the truss adapter, as in FIG. 9A;

FIG. 10A is a front-side view of an example first anchor in accordance with the disclosure;

FIG. 10B is a side-perspective view of a first end portion of the first anchor, as in FIG. 10A;

FIG. 11 is a schematic, perspective view of an example solar tracker truss foundation in accordance with the disclosure, embedded in a ground;

FIG. 12 is a front-side view of the solar tracker truss foundation, as in FIG. 11;

FIG. 13 is a side view of the solar tracker truss foundation, as in FIG. 11;

FIG. 14 is a front-side view of the solar tracker truss foundation, as in FIG. 11, with a first portion of a first upper leg removed;

FIG. 15 is an enlarged view of an upper portion of the solar tracker truss foundation with the first portion of the first upper leg removed, as in FIG. 14;

FIG. 16A is an enlarged view a lower connecting portion, as in Circle 16A of FIG. 15;

FIG. 16B is an enlarged view perspective view of an upper connecting portion, as in Circle 16B of FIG. 15;

FIG. 17A is a first side, perspective view of an example connector bracket in accordance with the disclosure;

FIG. 17B is a second side, perspective view of the example connector bracket, as in FIG. 17A;

FIG. 18A is a front-side view of an example first anchor in accordance with the disclosure; and

FIG. 18B is a side-perspective view of a first end portion of the first anchor, as in FIG. 18A.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

Solar tracking systems may be used to dynamically orient a plurality of solar modules, for instance, by moving the solar modules throughout the course of a given day to track the movement of the sun (e.g., an east-west direction) and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules. Embodiments disclosed herein may include piers and/or truss supports designed to increase the strength of the piers and/or truss supports in an east-west direction, as the solar modules track the movement of the sun. Further, the piers and/or truss supports disclosed herein may be designed to increase flexibility in a north-south direction, aligning with the length of the torque tube, to accommodate natural forces in the field, such as wind loads. In such cases, the piers and/or truss supports may flex with the wind thereby preventing deformation and/or damage due to forces placed upon the piers and/or truss supports.

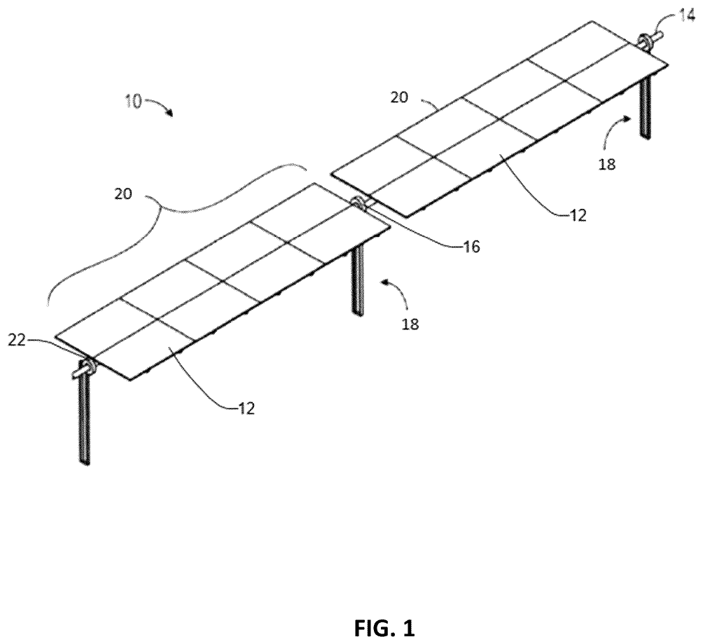

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

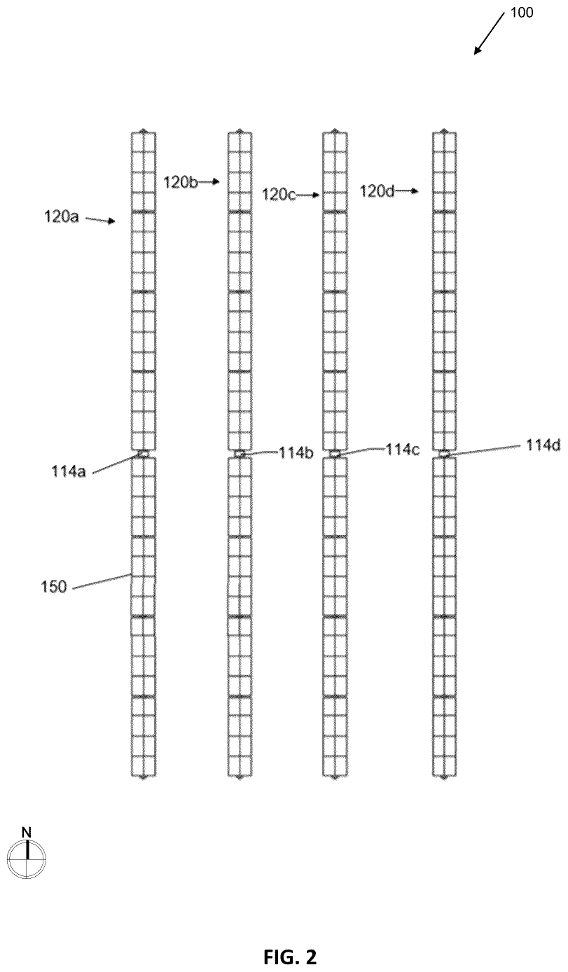

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

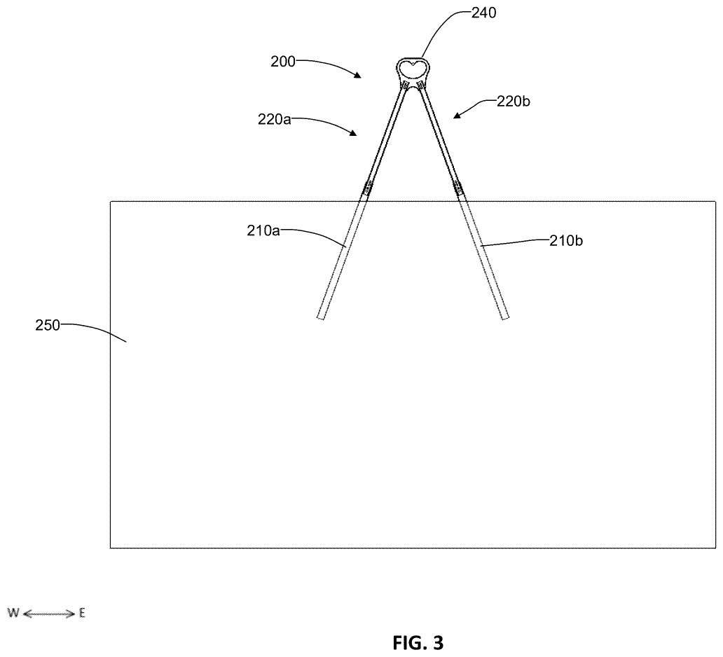

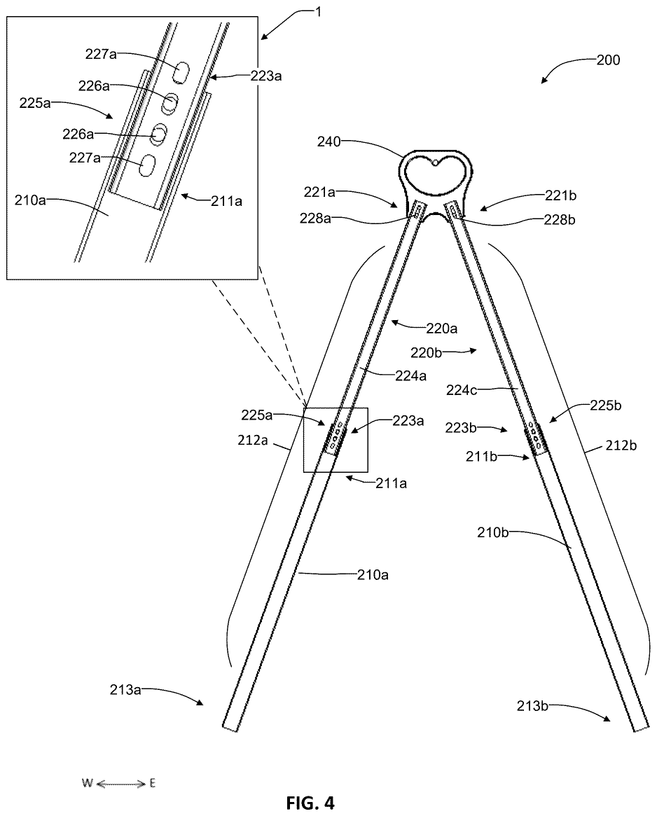

FIG. 3 is a schematic, perspective view of an example solar tracker truss foundation 200 embedded in a ground 250. The truss foundation 200 may include a pair of adjacent anchors 210a, 210b (generally referred to herein as anchors 210) that have been driven into supporting ground at angles to one another on the East and West sides of an intended North-South line of a tracker row. Once anchors 210 reach their target embedment depth, driving stops a truss cap or adapter 240 is held in place by a jig on the driving machine at the correct location to insure alignment with other truss caps or adapters in the same row. Then, upper legs 220a, 220b are coupled to each anchor and respective connecting portions of the truss adapter 240 to complete each truss leg 212, as will be discussed further herein with reference to FIG. 4.

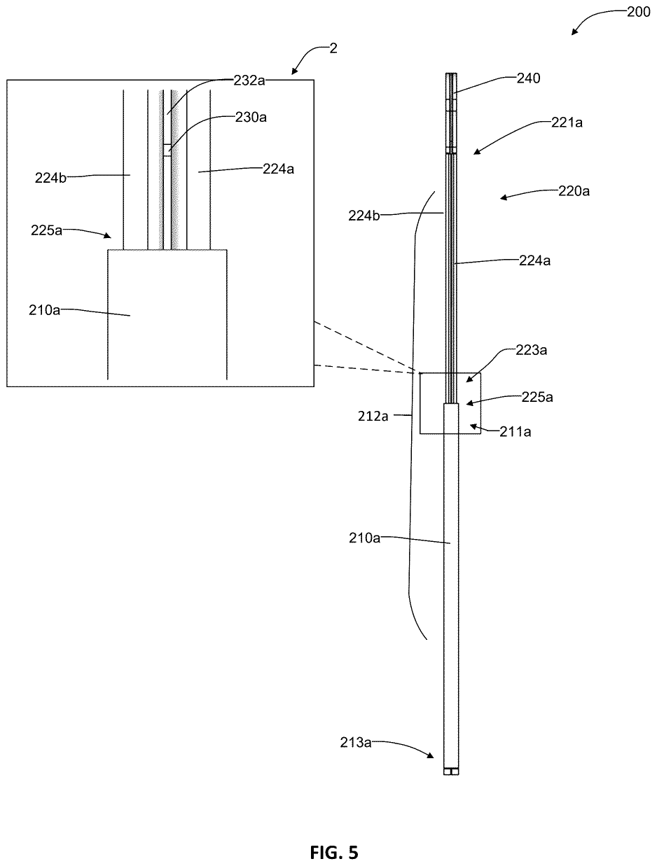

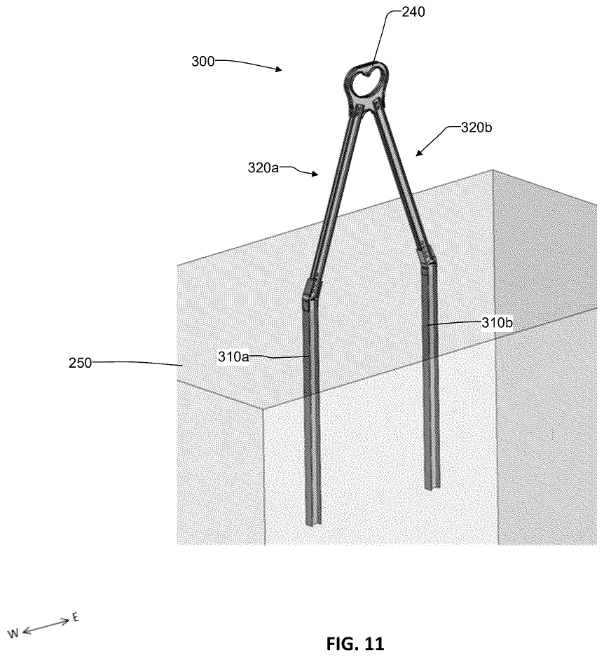

FIG. 4 is a front-side view of the solar tracker truss foundation 200, as in FIG. 3, and FIG. 5 is a side view of the solar tracker truss foundation 200. As shown in FIG. 4, the truss foundation 200 may include a first truss leg 212a and a second truss leg 212b. Optimal tracker performance often requires tight tolerances and specific locations for the foundations supporting their trackers. That means that the foundation needs to be in the right place along the row (x direction), at the right height (z direction), on the row, at the correct East or West along the row centerline (y direction). Moreover, the foundation should be specified pitch and roll (e.g., plumb, as in FIG. 11), and at the right yaw (aligned with the X axis with the flanges facing East-West). In some examples, most of this is achieved with precise placement of the machine and correct orientation of the mast to drive the anchors 210a, 210b along respective drive axes that intersect at the desired work point of the truss. All of these requirements add expense and time needed for the installation process. Embodiments of the present invention help increase installation tolerances, which should translate into reduced expense and time needed for installation.

Turning first to the first truss leg 212a, the first truss leg 212a may include a first elongated anchor 210a having a first end portion 211a and a second end portion 213a opposite the first end portion 211a. The second end portion 213a may be configured to be embedded into the ground 250, as shown in FIG. 3. In some examples, as shown herein, the first anchor 210a may be formed in a similar shape to that of an I-beam. In such cases, the first anchor 210a may be rammed into the ground 250 via a machine configured to engage the first end portion 211a and force the second end portion 213a of the first anchor 210a into the ground 250.

When the second end portion 213a of the first anchor 210a is embedded into the ground 250, the first end portion 211a may remain exposed above the ground 250, as shown in FIG. 3. Having the first end portion 211a exposed above the ground 250 allows the first anchor 210a to be coupled to (e.g., connected to) a first upper leg 220a. While it is shown that the first anchor 210a may be formed in the shape of an I-beam, it may be contemplated that the first anchor 210a may be any suitable beam capable of supporting a solar tracker system, such as, for example, T-shaped, L-shaped, H-shaped, etc. Further, in some examples, the second end portion 213a of the first elongated anchor 210a may include screw threads to allow the first anchor 210a to be screwed into the ground 250.

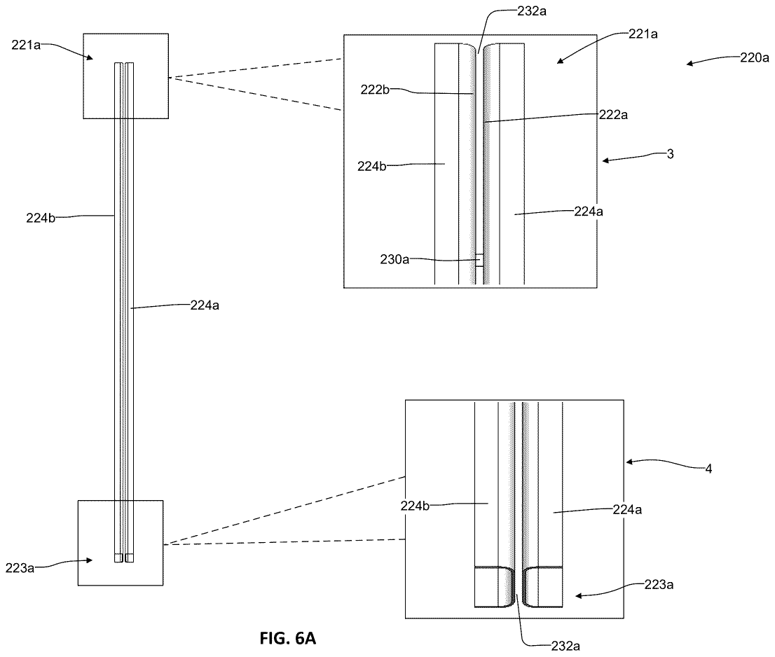

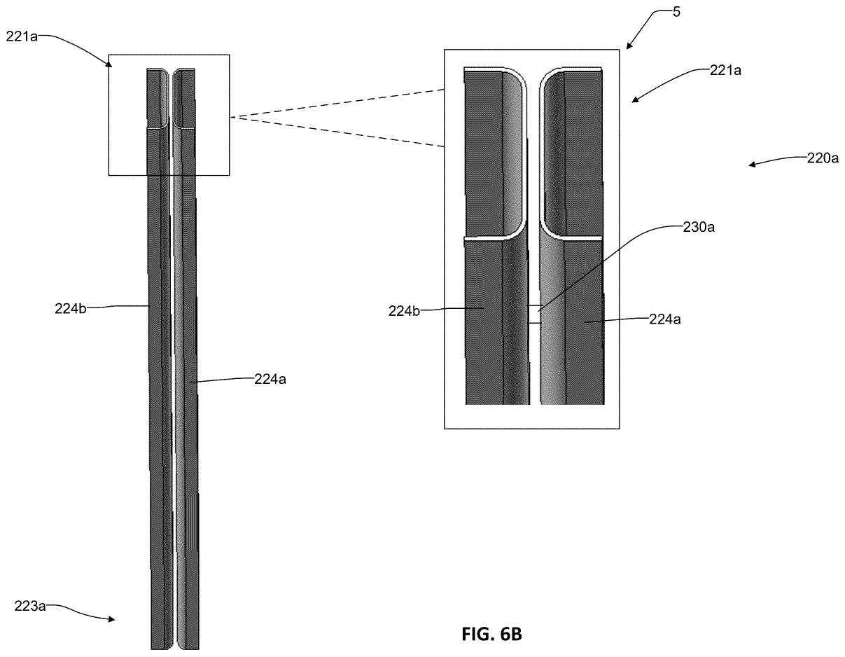

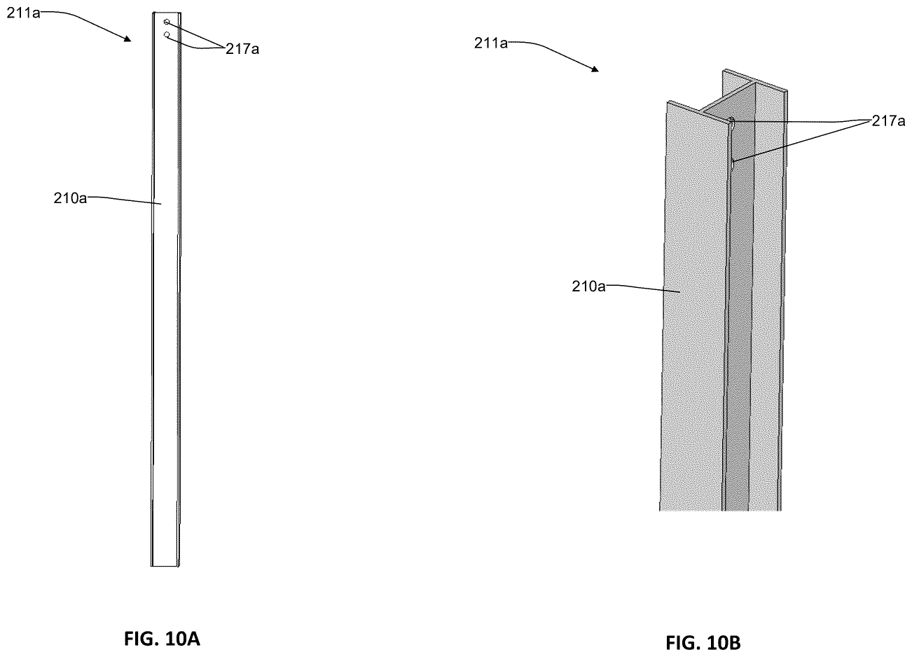

The first truss leg 212a may further include the first elongated upper leg 220a. The first upper leg 220a may be formed from a first leg portion 224a and a second leg portion 224b. The first leg portion 224a and the second leg portion 225b are shown in further detail with reference to FIGS. 6A to 6C. The first upper leg 220a may further include a first end portion 221a and a second end portion 223a opposite the first end portion 221a. The first end portion 221a of the first upper leg 220a may be configured to be coupled to the truss adapter 240, and the second end portion 223a of the first upper leg 220a may be configured to be coupled to the first end portion 211a of the first anchor 210a. For example, as shown in Square 1, the second end portion 223a of the first upper leg 220a may include a plurality of holes 227a that may be configured to align with one or more holes (FIGS. 10A to 10B) of the first anchor 210a to form a lower connecting surface 225a. One or more fasteners 226a may be configured to extend therethrough and tightly secure the second end portion 223a of the first upper leg 220a to the first end portion 211a of the first anchor 210a, thereby forming a slip critical joint. For example, a bobtail rivet may be used to secure the second end portion 223a of the first upper leg 220a at the lower connecting surface 225a of the first anchor 210a. Securing the first upper leg 220a to first anchor 210a in such a fashion forms the slip critical joint, which prevents rotation of the first upper leg 220a relative to the first anchor 210a. In some examples, the one or more fasteners 226a may not be a bobtail rivet, and instead may be a bolt, a screw, or other fastening mechanisms.

Turning to the second truss leg 212b, the second truss leg 212b may include a second elongated anchor 210b having a first end portion 211b and a second end portion 213b opposite the first end portion 211b. The second end portion 213b may be configured to be embedded into the ground 250, as shown in FIG. 3. In some examples, as shown herein, the second anchor 210b may be formed in the shape of an I-beam or the other beam shapes described herein. In such cases, the second anchor 210b may be rammed into the ground 250 via a machine configured to engage the first end portion 211b and force the second end portion 213b of the second anchor 210b into the ground 250.

When the second end portion 213b of the second anchor 210b is embedded into the ground 250, the first end portion 211b may remain exposed above the ground 250, as shown in FIG. 3. Having the first end portion 211b exposed above the ground 250 allows the second anchor 210b to be coupled to (e.g., connected to) a second upper leg 220b. In some examples, the second end portion 213b of the second elongated anchor 210b may include screw threads to allow the second anchor 210b to be screwed into the ground 250. In some examples, the first anchor 210a and the second anchor 210b may include the same profile or may include different profiles, depending on the installation needs of the solar tracking system (e.g., solar tracking system 10).

The second truss leg 212b may further include the second elongated upper leg 220b. The second upper leg 220b may be formed from a third leg portion 224c and a fourth leg portion 224d. The third leg portion 224c and the fourth leg portion 225d are like the first leg portion 224a and the second leg portion 224b shown in further detail with reference to FIGS. 6A to 6C. The second upper leg 220b may further include a first end portion 221b and a second end portion 223b opposite the first end portion 221b. The first end portion 221b of the second upper leg 220b may be configured to be coupled to the truss adapter 240, and the second end portion 223b of the second upper leg 220b may be configured to be coupled to the first end portion 211b of the second anchor 210b. See, for example the description with reference to Square 1, which further applies to the second truss leg 212b.

FIG. 6A is a side view of the first upper leg 220a, FIG. 6B is a top-down perspective view of the first upper leg 220a, and FIG. 6C is perspective view of the first upper leg 220a. As previously discussed, the first upper leg 220a may be formed from the first leg portion 224a and the second leg portion 224b. The first leg portion 224a. The first upper leg 220a may be formed from steel, aluminum, or the like. The first leg portion 224a and the second leg portion 224b may each be roll formed to create C-Channel shaped cross-section or an L-shaped cross-section based frames. For example, the first leg portion 224a and the second leg portion 224b may include a generally C-shaped cross-sectional profile. Formation of the first upper leg 220a may include positioning a first planar side 222a (e.g., back side) of the “C-Channel” first leg portion 224a adjacent to a second planar side 222b (e.g., back side) of the “C-Channel” second leg portion 224b, such that the first leg portion 224a and the second leg portion 224b are generally “back-to-back”. The first leg portion 224a and the second leg portion 224b may be coupled together to form the first upper leg 220a via welding, adhesives, mechanical fasteners (e.g., bolts, screws, rivets), or any other suitable method of attachment as desired, as referenced by 230a in FIG. 5 and FIGS. 6A to 6B.

As shown in FIGS. 6A to 6C, the first upper leg 220a may include a first gap 232a formed between the first leg portion 224a and the second leg portion 224b, when the first planar side 222a and the second planar side 222b are positioned adjacent one another. The first gap 232a may extend from the first end portion 221a of the first upper leg 220a to the second end portion 223a of the first upper leg 220a, as shown in Square 3 and Square 4. The first gap 232a may include a size sufficient to permit the first connecting surface 242a to slide within the first gap 232a between the first leg portion 224a and the second leg portion 224b at the first end portion 221a, and the lower connecting surface 225a to slide within the first gap 232a between the first leg portion 224a and the second leg portion 224b at the second end portion 223a.

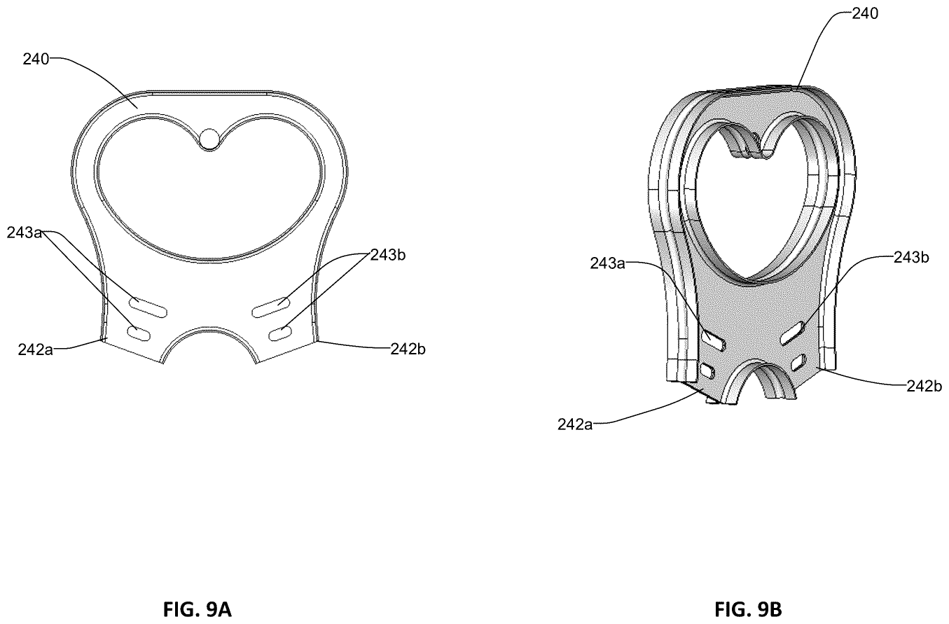

As shown in Square 6 in FIG. 6C, the first end portion 221a of the first upper leg 220a may include one or more holes 229a, which may be configured to align with one or more slots (FIGS. 9A to 9B) on the truss adapter 240. Alignment of the one or more holes 229a with the one or more slots allows for a coupling mechanism to extend therethrough. For example, a bobtail rivet may be used to secure the first end portion 221a of the first upper leg 220a to the first connecting surface 242a of the truss adapter 240. Further, as shown in Square 7 in FIG. 6C, the second end portion 223a may include a plurality of holes 227a which may be configured to align with one or more holes 217 (FIGS. 10A to 10B). Alignment of the plurality of holes 227a with the one or more holes 217 allows for a coupling mechanism to extend therethrough. For example, a bobtail rivet may be used to secure the second end portion 223a of the first upper leg 220a to the lower connecting surface 225a of the first anchor 210a. Securing the first upper leg 220a to first anchor 210a in such a fashion forms a slip critical joint, which prevents rotation of the first upper leg 220a relative to the first anchor 210a. While the first upper leg 220a is described with reference to FIGS. 6A to 6C, it will be appreciated that the description of the first upper leg 220a further applies to the second upper leg 220b.

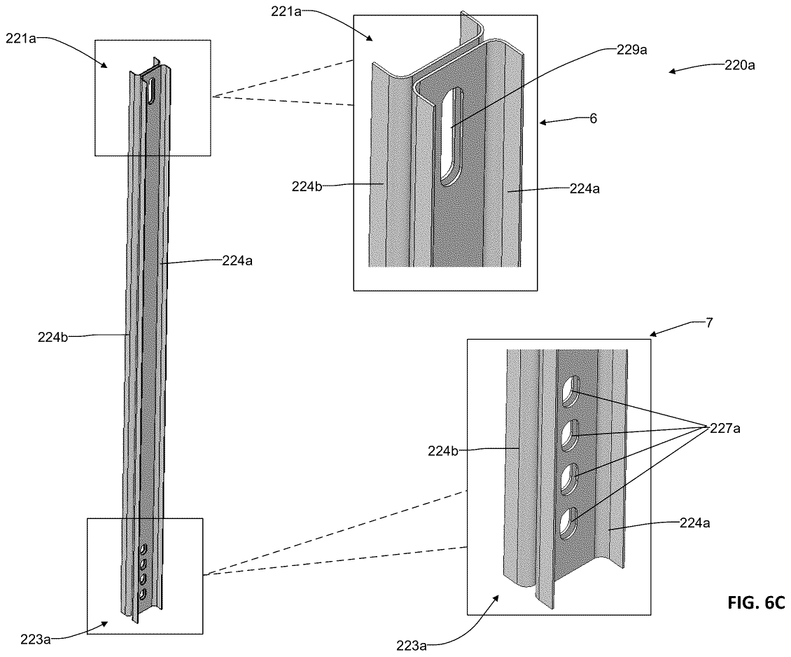

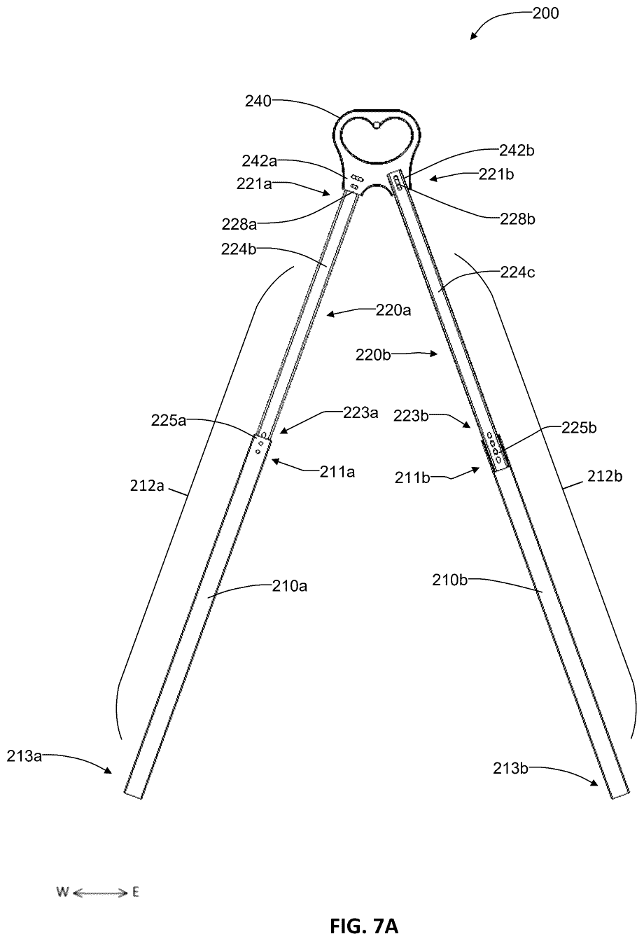

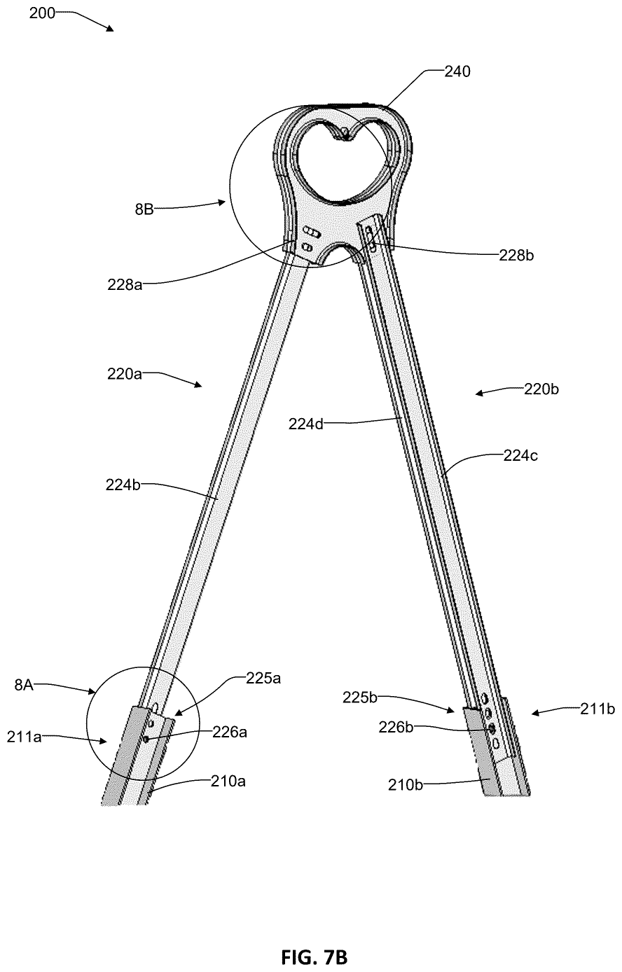

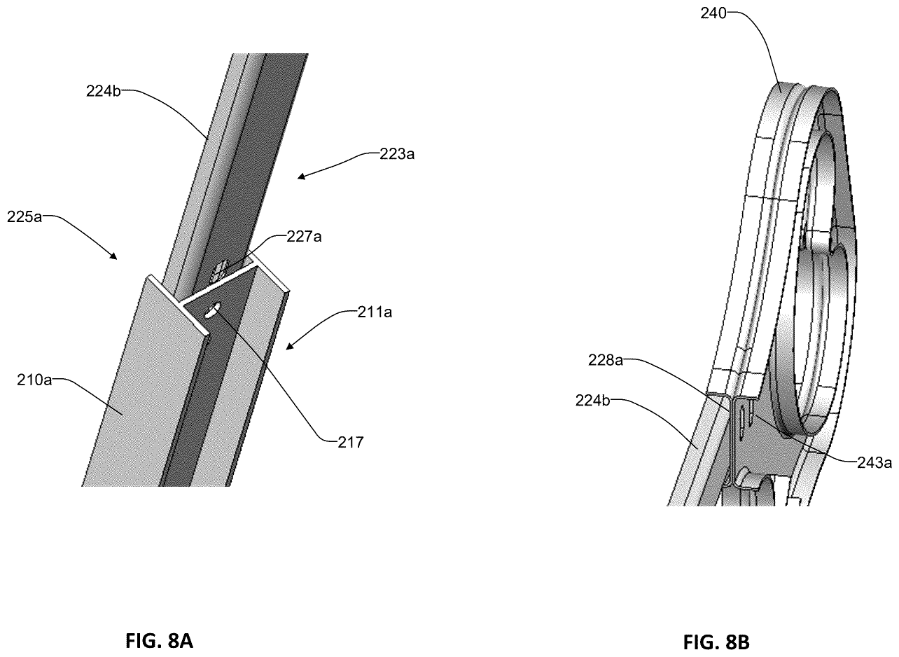

FIG. 7A is a front-side view of the solar tracker truss foundation 200, as in FIG. 3, with the first leg portion 224a of a first upper leg 220a removed, and FIG. 7B is an enlarged view of an upper portion of the solar tracker truss foundation 200 with the first leg portion 224a of the first upper leg 220a removed. FIG. 8A is an enlarged view of the lower connecting surface 225a, as in Circle 8A of FIG. 7B, and FIG. 8B is an enlarged view of an underside view of the upper connecting portion 228a, as in Circle 8B of FIG. 7B.

As shown in FIGS. 7A to 8A, the first end portion 211a of the first anchor 210a may be configured such that the first leg portion 224a and the second leg portion 224b of the first upper leg 220a may sandwich the first end portion 211a of the first anchor 210a therebetween within the first gap 232a. As such, the plurality of holes 227a of the first leg portion 224a and the second leg portion 224b align with the one or more holes 217 of the first anchor 210a. As previously stated, alignment of the plurality of holes 227a with the one or more holes 217 allows for a coupling mechanism to extend therethrough. For example, a bobtail rivet may be used to secure the second end portion 223a of the first upper leg 220a to the lower connecting surface 225a of the first anchor 210a. Securing the first upper leg 220a to first anchor 210a in such a fashion forms a slip critical joint, which prevents rotation of the first upper leg 220a relative to the first anchor 210a.

Further, as shown in FIGS. 7A, 7B, and 8B, the first leg portion 224a and the second leg portion 224b of the first upper leg 220a may sandwich the first connecting surface 242a of the truss adapter 240 therebetween within the first gap 232a. As such, the first end portion 221a of the first upper leg 220a may include one or more holes 229a, which may be configured to align with one or more slots on the truss adapter 240. Alignment of the one or more holes 229a with the one or more slots allows for a coupling mechanism to extend therethrough. For example, a bobtail rivet may be used to secure the first end portion 221a of the first upper leg 220a to the first connecting surface 242a of the truss adapter 240. While the first upper leg 220a is described with reference to FIGS. 7A to 8B, it will be appreciated that the description of the first upper leg 220a further applies to the second upper leg 220b.

FIG. 9A is a front-side view of the example truss adapter 240, and FIG. 9B is a side-perspective view of the truss adapter 240. As shown in FIGS. 9A and 9B, the truss adapter 240 may provide a pair of spaced-apart pedestals that may support opposing feet of a bearing housing assembly (BHA). Although not explicitly shown, a BHA may be a cardioid-shaped hoop with bearing proximate to the cusp. It should be appreciated that other variants are possible as long as the bearing location enables the torque tube to be suspended from a bearing pin rather than rotating about its own axis. Bearing pin may be received within bearing and may extend out of both sides of BHA. A torque tube module bracket may be suspended from either side of bearing pin. Brackets may be configured to support the torque tube (e.g., torque tube 14) and attach to the frame of at least one adjacent photovoltaic module or solar panel (e.g., solar module 12). In this type of tracker system, the drive motor's drive axis may be aligned with bearing pin rather than the torque tube, so that as the motor's output shaft rotates, the torque tube swings through an arc that is bounded on either side by the BHA. This may be accomplished by a bend in the torque tube on both sides of the drive motor.

The truss adapter 240 may further include the first connecting surface 242a and the second connecting surface 242b. The first connecting surface 242a and the second connecting surface 242b may be configured to engage with the first upper leg 220a and the second upper leg 220b, respectively, thereby forming the upper connecting portion 228a, 228b. As discussed, the first upper leg 220a is formed from the first leg portion 224a and the second leg portion 224b. The first gap 232a and the second gap 232b formed therebetween may provide adequate space to receive the first connecting surface 242a and the second connecting surface 242b, respectively, so as to provide a tight, friction fit between the first connecting surface 242a and the first upper leg 220a, and the second connecting surface 242b and the second upper leg 220b.

In use, when the first connecting surface 242a is positioned within the first gap 232a, one or more slots 243a may align with one or more holes 229a (holes 229a shown in further detail with reference to FIG. 6C). The truss adapter 240 may be connected to the first upper leg 220a via one or more bolts, screws, rivets (e.g., bobtail rivets), adhesives, or any other suitable method of connection as desired. Similarly, when the second connecting surface 242b is positioned within the second gap 232b, one or more slots 243b may align with one or more holes (holes are like holes 229a shown in further detail with reference to FIG. 6C). The truss adapter 240 may be connected to the second upper leg 220b via one or more mechanical fasteners (e.g., bolts, screws, rivets (e.g., bobtail rivets)), adhesives, welding, or any other suitable method of connection as desired.

FIG. 10A is a front-side view of the first anchor 210a, and FIG. 10B is a side-perspective view of the first end portion 211a of the first anchor 210a. As previously discussed, the first elongated anchor 210a may include the first end portion 211a and the second end portion 213a opposite the first end portion 211a. The second end portion 213a may be configured to be embedded into the ground 250, as shown in FIG. 3. In some examples, as shown herein, the first anchor 210a may in the shape of an I-beam. In such cases, the first anchor 210a may be rammed into the ground 250 via a machine configured to engage the first end portion 211a and force the second end portion 213a of the first anchor 210a into the ground 250.

When the second end portion 213a of the first anchor 210a is embedded into the ground 250, the first end portion 211a may remain exposed above the ground 250, as shown in FIG. 3. Having the first end portion 211a exposed above the ground 250 allows the first anchor 210a to be coupled to (e.g., connected to) a first upper leg 220a. While it is shown that the first anchor 210a may be formed in the shape of an I-beam, it may be contemplated that the first anchor 210a may be any suitable beam capable of supporting a solar tracker system, such as, for example, H-beams, box beams, circular or round beams, etc. Further, in some examples, the second end portion 213a of the first elongated anchor 210a may include screw threads to allow the first anchor 210a to be screwed into the ground 250.

As shown in FIGS. 10A to 10B, the first end portion 211a of the first anchor 210a may include one or more holes 217 which may be configured to align with the plurality of holes 227a of the second end portion 223a of the first upper leg 220a. Alignment of the plurality of holes 227a with the one or more holes 217 allows for a coupling mechanism to extend therethrough. For example, a bobtail rivet may be used to secure the second end portion 223a of the first upper leg 220a to the lower connecting surface 225a of the first anchor 210a. Securing the first upper leg 220a to first anchor 210a in such a fashion forms a slip critical joint, which prevents rotation of the first upper leg 220a relative to the first anchor 210a. While the first anchor 210a is described with reference to FIGS. 10A to 10B, it will be appreciated that the description of the first anchor 210a further applies to the second anchor 210b.

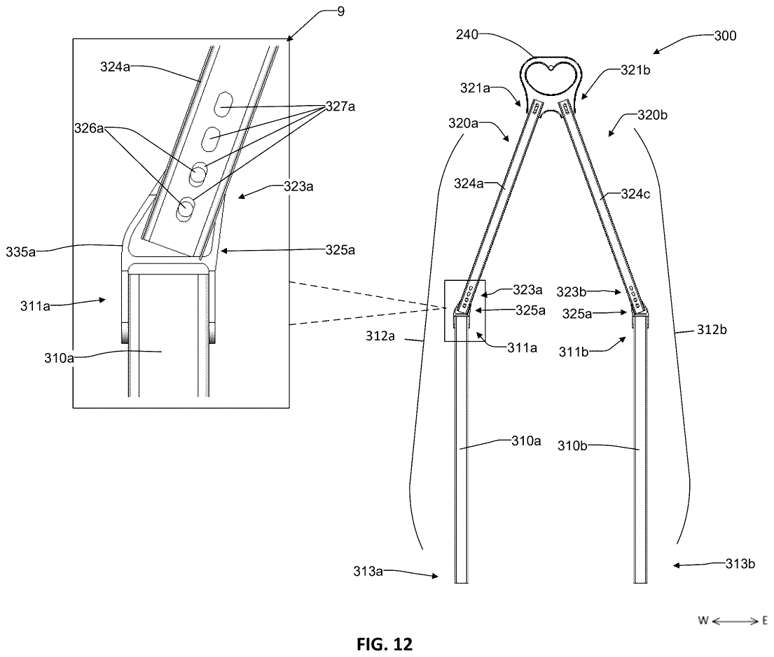

FIG. 11 is a schematic, perspective view of a solar tracker truss foundation 300 embedded in the ground 250. The truss foundation 300 may include a pair of adjacent anchors 310a, 310b (generally referred to herein as anchors 310) that have been driven into supporting ground at angles to one another on the East and West sides of an intended North-South line of a tracker row. Once anchors 310 reach their target embedment depth, driving stops a truss cap or adapter 240, as described herein, is held in place by a jig on the driving machine at the correct location to insure alignment with other truss caps or adapters in the same row. Then, upper legs 320a, 320b are coupled to each anchor and respective connecting portions of the truss adapter 240 to complete each truss leg 312, as will be discussed further herein with reference to FIG. 12.

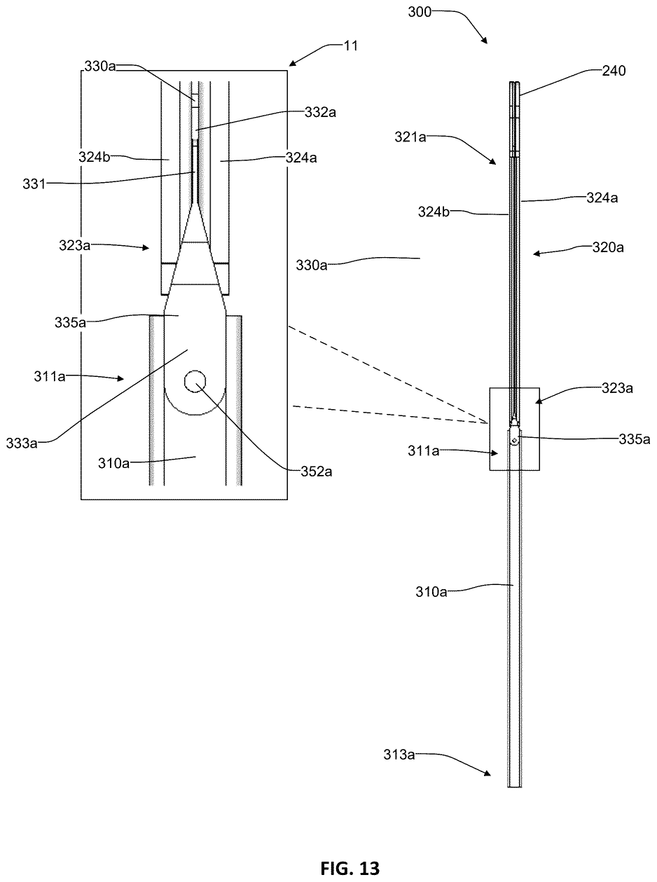

FIG. 12 is a front-side view of the solar tracker truss foundation 300, and FIG. 13 is a side view of the solar tracker truss foundation 300. Turning first to a first truss leg 312a, it will be appreciated that the first truss leg 312a is like the first truss leg 212a, as in FIGS. 4 to 10B. However, the first truss leg 312a differs from the first truss leg 212a in that the first truss leg 312a may include a first connector bracket 335a configured to couple a first upper leg 320a to a first anchor 310a.

As shown in FIG. 12, the first truss leg 312a may include the first elongated anchor 310a having a first end portion 311a and a second end portion 313a opposite the first end portion 311a. The second end portion 313a may be configured to be embedded into the ground 250, as shown in FIG. 11. In some examples, as shown herein, the first anchor 310a may be formed from a box-beam. In such cases, the first anchor 310a may be rammed into the ground 250 via a machine configured to engage the first end portion 311a and force the second end portion 313a of the first anchor 310a into the ground 250.

When the second end portion 313a of the first anchor 310a is embedded into the ground 250, the first end portion 311a may remain exposed above the ground 250, as shown in FIG. 11. Having the first end portion 311a exposed above the ground 250 allows the first anchor 310a to be coupled to (e.g., connected to) a first upper leg 320a. While it is shown that the first anchor 310a may be formed from a box-beam, it may be contemplated that the first anchor 310a may be any suitable beam capable of supporting a solar tracker system, such as, for example, I-beams, H-beams, T-beams, L-beams, etc. Further, in some examples, the second end portion 313a of the first elongated anchor 310a may include screw threads to allow the first anchor 310a to be screwed into the ground 250.

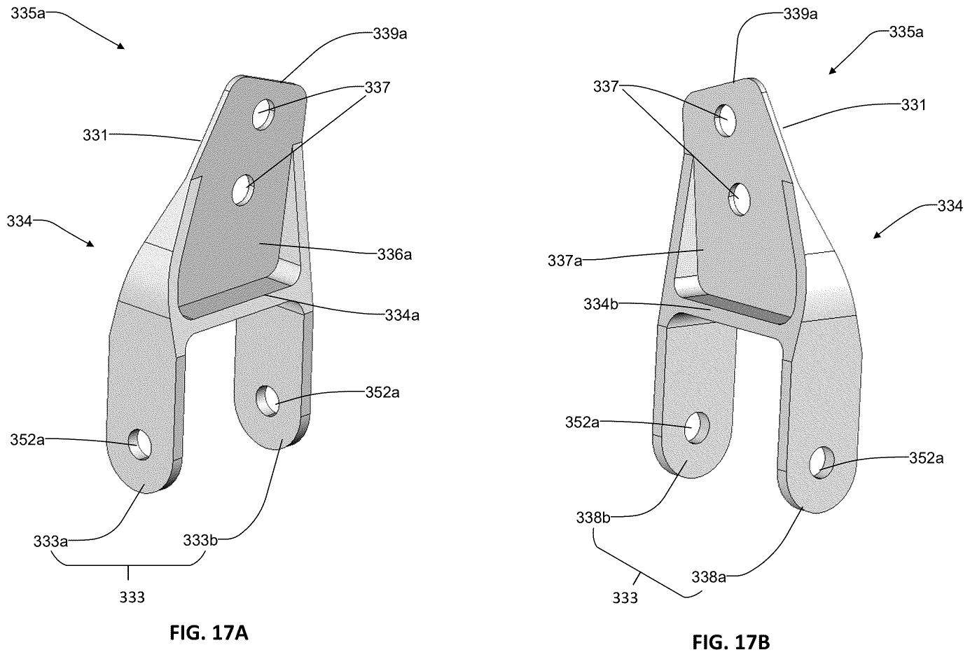

The first truss leg 312a may further include the first elongated upper leg 320a. The first upper leg 320a may be like the first upper leg 220a described in reference to FIGS. 4 to 10B. The first upper leg 320a may be formed from a first leg portion 324a and a second leg portion 324b. The first upper leg 320a may further include a first end portion 321a and a second end portion 323a. The first end portion 321a of the first upper leg 320a may be configured to be coupled to the truss adapter 240, and the second end portion 323a of the first upper leg 320a may be configured to be coupled to the first connector bracket 335a. The first connector bracket 335a is further coupled to the first end portion 311a of the first anchor 310a. For example, as shown in Square 9, the second end portion 323a of the first upper leg 320a may include a plurality of holes 327a that may be configured to align with one or more holes of the first connector bracket 335a. The first connector bracket 335a is further connected to the first end portion 311a of the first anchor 310a to form a lower connecting surface 325a. One or more fasteners 326a may be configured to extend through the plurality of holes 327a of the second end portion 323a of the first upper leg 320a and the one or more holes of the first connector bracket 335a. The one or more holes of the first connector bracket 335a are shown in further detail with reference to FIGS. 17A and 17B. The one or more fasteners 326a may tightly secure the second end portion 323a of the first upper leg 320a to the first end portion 311a of the first anchor 310a, via the first connector bracket 335a, thereby forming a slip critical joint. For example, a bobtail rivet may be used to secure the second end portion 323a of the first upper leg 320a at the lower connecting surface 325a of the first anchor 310a. Securing the first upper leg 320a to first anchor 310a in such a fashion forms the slip critical joint, which prevents rotation of the first upper leg 320a relative to the first anchor 310a. In some examples, the one or more fasteners 326a may not be a bobtail rivet, and instead may be a bolt, a screw, or the like.

As shown in Square 11 of FIG. 13, the first upper leg 320a may include a first gap 332a formed between the first leg portion 324a and the second leg portion 324b, which may extend from the first end portion 321a of the first upper leg 320a to the second end portion 323a of the first upper leg 320a. The first gap 332a may include a size sufficient to permit the first connecting surface 242a of the truss adapter 240 to slide within the first gap 332a between the first leg portion 324a and the second leg portion 324b at the first end portion 321a, and the lower connecting surface 325a to slide within the first gap 332a between the first leg portion 324a and the second leg portion 324b at the second end portion 323a. It will be appreciated that the description of the first truss leg 312a further applies to the second truss leg 312b.

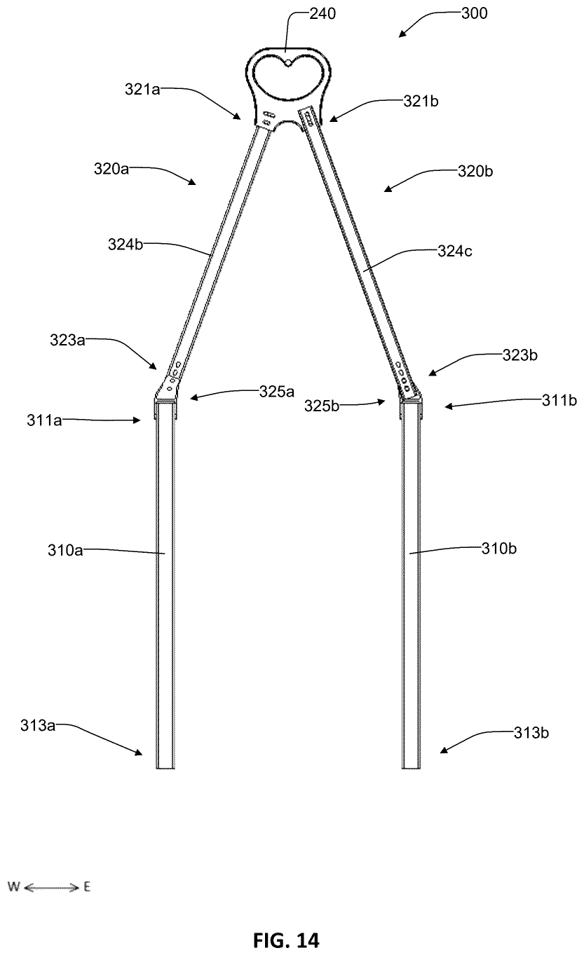

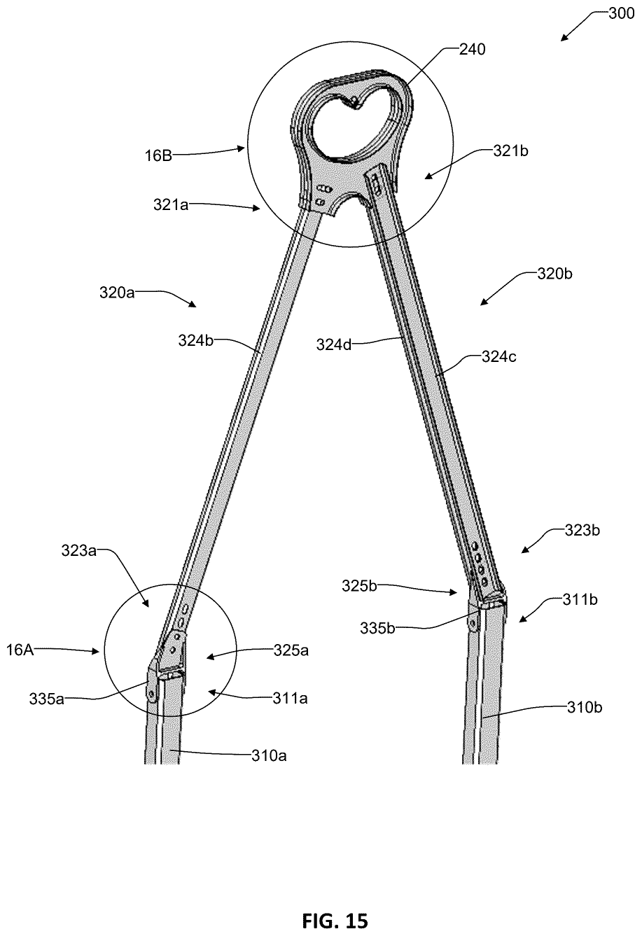

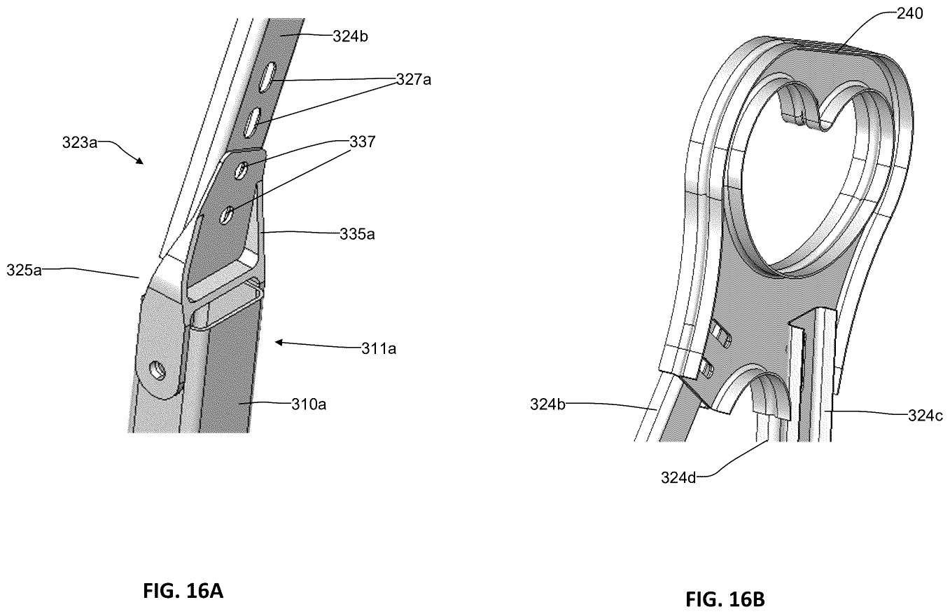

FIG. 14 is a front-side view of the solar tracker truss foundation 300 with the first leg portion 324a of the first upper leg 320a removed, and FIG. 15 is an enlarged view of the solar tracker truss foundation 300 with the first leg portion 324a of the first upper leg 320a removed. FIG. 16A is an enlarged view of the lower connecting portion, as in Circle 16A of FIG. 15, and FIG. 16B is an enlarged view the upper connecting portion, as in Circle 16B of FIG. 15.

As shown in FIGS. 14 to 16A, the lower connecting surface 325a of the first anchor 310a may be configured such that the first leg portion 324a and the second leg portion 324b of the first upper leg 320a may sandwich an upper portion of the first connector bracket 335a (lower connecting surface 325a) therebetween within the first gap 332a. As such, the plurality of holes 327a of the first leg portion 324a and the second leg portion 324b align with the one or more holes 337 of the first connector bracket 335a. As previously stated, alignment of the plurality of holes 327a with the one or more holes 337 allows for a coupling mechanism to extend therethrough. For example, a bobtail rivet may be used to secure the second end portion 323a of the first upper leg 320a to the lower connecting surface 325a of the first anchor 310a. Securing the first upper leg 320a to first anchor 310a in such a fashion forms a slip critical joint, which prevents rotation of the first upper leg 320a relative to the first anchor 310a.

Further, as shown in FIGS. 14, 15, and 16B, the first leg portion 324a and the second leg portion 324b of the first upper leg 320a may sandwich the first connecting surface 242a of the truss adapter 240 therebetween within the first gap 332a. As such, the first end portion 321a of the first upper leg 320a may include one or more holes 329a, which may be configured to align with one or more slots on the truss adapter 240. Alignment of the one or more holes 329a with the one or more slots allows for a coupling mechanism to extend therethrough. For example, a bobtail rivet may be used to secure the first end portion 321a of the first upper leg 320a to the first connecting surface 242a of the truss adapter 240. While the first upper leg 320a is described with reference to FIGS. 14 to 16B, it will be appreciated that the description of the first upper leg 320a further applies to the second upper leg 320b

FIG. 17A is a first side 336a, perspective view of the first connector bracket 335a, and FIG. 17B is a second side 337a, perspective view of the first connector bracket 335a. The first connector bracket 335a may include an upper portion 331, a lower portion 333 and a middle portion 334. The upper portion 331 may include a planar surface 339a configured to extend in a first direction (upward) from the middle portion 334 and may include one or more holes 337 within the planar surface 339a configured to align with the plurality of holes 327a of the second end portion 323a of the first upper leg 320a. The lower portion 333 may include a first arm 333a and a second arm 333b opposite the first arm 333a. The first arm 333a and the second arm 333b may extend in a second direction (downward) from the middle portion 334 and may be configured to engage with opposing outer surfaces of the first end portion 311a of the first anchor 310a. Each of the first arm 333a and the second arm 333b may include one or more holes 352a. The one or more holes 352a of each of the first arm 333a and the second arm 333b may be configured to align with one or more holes 317 of the first end portion 311a of the first anchor 310a. Alignment of the one or more holes 317 with the one or more holes 352a allows for a coupling mechanism to extend therethrough. For example, a mechanical fastener, such as a bobtail rivet, a bolt, a screw, or the like, may be used to secure the first connector bracket 335a to the first end portion 311a of the first anchor 310a to form the lower connecting surface 325a.

The upper portion 331 of the first connector bracket 335a may include a planar surface 339a configured to engage with the first gap 332a formed between the first leg portion 324a and the second leg portion 324b. In use, the planar surface 339a of the upper portion 331 of the first connector bracket 335a (e.g., the lower connecting surface 325a), is positioned within the first gap 332a, and the one or more holes 337 may align with one or more holes 327a of the second end portion 323a of the first upper leg 320a. The first connector bracket 335a may be connected to the first upper leg 320a via one or more bolts, screws, rivets (e.g., bobtail rivets), adhesives, or any other suitable method of connection as desired. Similarly, when a planar portion of a second connector bracket 335b is positioned within the second gap 332b, the one or more holes 337 may align with one or more holes 327b of the second end portion 323b of the second upper leg 320b. The second connector bracket 335b may be connected to the second upper leg 320b via one or more mechanical fasteners (e.g., bolts, screws, rivets (e.g., bobtail rivets)), adhesives, welding, or any other suitable method of connection as desired.

The middle portion 334 of the first connector bracket 335a may include a first ledge region 334a and a second ledge region 334b that may be configured to engage with the second end portion 323a of the first upper leg 320a. For example, when second end portion 323a engages with the upper portion 331 of the first connector bracket 335a, the first leg portion 324a may “sit in”, or be supported, within the first ledge region 334a and the second leg portion 324b may “sit in”, or be supported, within the second ledge region 334b. When the second end portion 323a of the first upper leg 320a is coupled to the first connector bracket 335a, the first connector bracket 335a holds the first upper leg 320a in an angled position, such that the first end portion 321a of the first upper leg 320a is angled in a direction towards the first end portion 321b of the second upper leg 320b. The first connector bracket 335a further permits the first anchor 310a to be embedded within the ground 250 in a plumb direction, as shown in FIGS. 11 to 14. While the first connector bracket 335a is described with reference to FIGS. 17A to 17B, it will be appreciated that the description of the first connector bracket 335a further applies to the second connector bracket 335b.

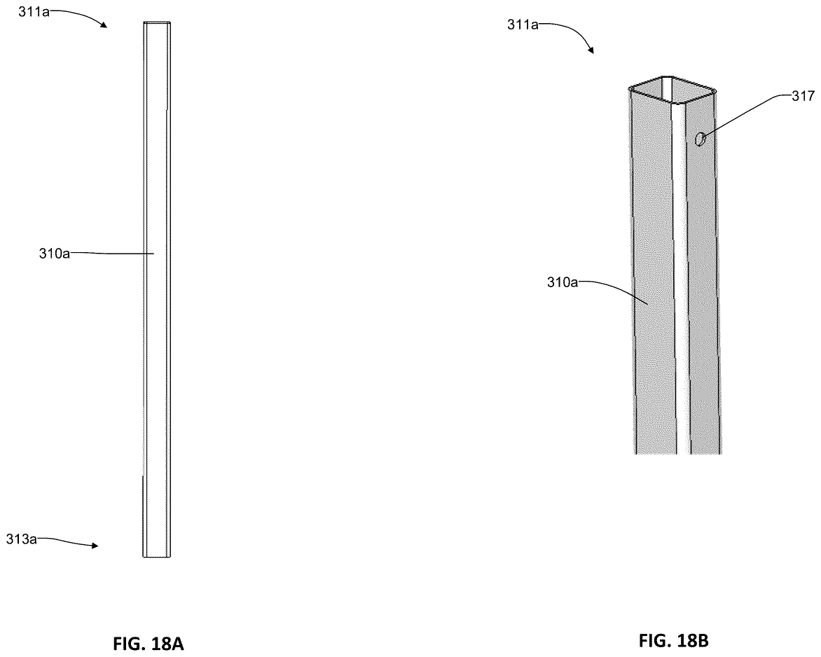

FIG. 18A is a front-side view of the first elongated anchor 310a, and FIG. 18B is a side-perspective view of the first end portion 311a of the first anchor 310a. As previously discussed, the first elongated anchor 310a may include the first end portion 311a and the second end portion 313a opposite the first end portion 311a. The second end portion 313a may be configured to be embedded into the ground 250, as shown in FIG. 11. In some examples, as shown herein, the first anchor 310a may be formed from a box-beam. In such cases, the first anchor 310a may be rammed into the ground 250 via a machine configured to engage the first end portion 311a and force the second end portion 313a of the first anchor 310a into the ground 250.

When the second end portion 313a of the first anchor 310a is embedded into the ground 250, the first end portion 311a may remain exposed above the ground 250, as shown in FIG. 11. Having the first end portion 311a exposed above the ground 250 allows the first anchor 310a to be coupled to (e.g., connected to) a first upper leg 320a via the first connector bracket 335a. While it is shown that the first anchor 310a may be formed from a box-beam, it may be contemplated that the first anchor 310a may be any suitable beam capable of supporting a solar tracker system, such as, for example, I-beams, H-beams, L-beams, T shaped beams. Further, in some examples, the second end portion 313a of the first elongated anchor 310a may include screw threads to allow the first anchor 310a to be screwed into the ground 250. Although generally illustrated as having a rectangular outer profile, other suitable profiles are contemplated, such as, for example, square, hexagonal, circular, oval, etc.

As shown in FIGS. 18A to 18B, the first end portion 311a of the first anchor 310a may include one or more holes 317 which may be configured to align with one or more holes 352a of a lower portion 333 of the first connector bracket 335a. Alignment of the one or more holes 317 with the one or more holes 352a allows for a coupling mechanism to extend therethrough. For example, a mechanical fastener, such as a bobtail rivet, a bolt, a screw, or the like, may be used to secure the first connector bracket 335a to the first end portion 311a of the first anchor 310a to form the lower connecting surface 325a. While the first anchor 310a is described with reference to FIGS. 18A to 18B, it will be appreciated that the description of the first anchor 310a further applies to the second anchor 310b.

Various non-limiting exemplary embodiments have been described. It will be appreciated that suitable alternatives are possible without departing from the scope of the examples described herein.

1. A truss foundation comprising:
a pair of truss legs, each truss leg comprising:
an elongated anchor having a top end portion and a bottom end portion opposite the top end portion; and
an elongated upper leg comprising a first leg portion and a second leg portion, the first leg portion having a first planar side and the second leg portion having a second planar side, the first planar side positioned adjacent the second planar side and defining a gap therebetween, the first leg portion and the second leg portion configured to couple with the top end portion of the elongated anchor at a second end portion of the elongated upper leg; and
an adapter having a main body and a pair of connecting surfaces projecting away from the main body and spaced apart by an angle in a range of more than 35-degrees up to and including 70-degrees, the adapter configured to couple with a first end portion of each of the elongated upper legs to form an A-frame shaped truss structure.

2. The truss foundation of claim 1, wherein the first leg portion and the second leg portion are roll formed to include a generally C-shaped profile.

3. The truss foundation of claim 1, wherein the top end portion of the elongated anchor includes a connecting surface, and the top end portion of the elongated anchor is joined to the second end portion of the elongated upper leg by positioning the connecting surface within the gap formed between the first leg portion and the second leg portion.

4. The truss foundation of claim 1, wherein the elongated anchor is formed from one of an I-beam or a box beam.

5. The truss foundation of claim 1, wherein each truss leg further comprises a connector bracket configured to join the top end portion of the elongated anchor to the second end portion of the elongated upper leg.

6. The truss foundation of claim 5, wherein joining the top end portion of the elongated anchor and the second end portion of the elongated upper leg via the connector bracket forms a slip critical connection preventing relative rotation therebetween.

7. The truss foundation of claim 5, wherein the connector brackets are configured to hold the elongated upper legs at angles such that the first end portion of one of the elongated upper legs extends in a direction towards the other first end portion of the elongated upper legs, and the connector bracket is further configured to hold each respective elongated anchor plumb.

8. The truss foundation of claim 5, wherein the connector brackets each comprise an upper portion, a middle portion, and a lower portion, the lower portion including a first arm and a second arm opposite the first arm, the first arm and the second arm defining one or more holes configured to align with one or more holes defined by the elongated anchor.

9. The truss foundation of claim 8, wherein the middle portion includes a first ledge region and a second, opposing ledge region, the first ledge region configured to engage with the first leg portion and the second ledge region configured to engage with the second leg portion at the second end portion of each elongated upper leg.

10. The truss foundation of claim 8, wherein the upper portion of each connector bracket includes a planar surface defining one or more holes, and the first leg portion and the second leg portion of each elongated upper leg define one or more holes proximate the second end portion of the elongated upper leg, and the one or more holes defined by the upper portion configured to align with the one or more holes defined by the second end portion of each of the elongated upper legs.

11. The truss foundation of claim 10, wherein the planar surface of the upper portion of the connector bracket is configured to be positioned within the gap between the first leg portion and the second leg portion at the second end portion of each elongated upper leg.

12. The truss foundation of claim 1, wherein when the elongated anchor and the elongated upper leg of each truss leg are joined together at the top end portion of the elongated anchor and the second end portion of the elongated upper leg, the elongated anchor and the elongated upper leg define a substantially common axis.

13. The truss foundation of claim 1, wherein the joining together of the top end portion of the elongated anchor and the second end portion of the elongated upper leg of each truss leg forms a slip critical connection.

14. A truss structure comprising:
a pair of truss legs, each truss leg comprising:
an anchor having a top end and a bottom end;
a first leg portion and a second leg portion couplable to the top end of the anchor at a second end of the first leg portion and the second leg portion, the first leg portion having a first planar side and the second leg portion having a second planar side, the first planar side positioned adjacent the second planar side and defining a gap therebetween; and
an adapter configured to couple with each truss leg to form a shaped truss structure, the adapter configured to couple with the first leg portion and the second leg portion at a first end of the first leg portion and the second leg portion of each truss leg.

15. The truss structure of claim 14, wherein the first leg portion and the second leg portion are roll formed to include a generally C-shaped profile.

16. The truss structure of claim 14, wherein for each truss leg, the top end of the anchor includes a connecting surface to which the first leg portion and the second leg portion couple, the connecting surface positioned in the gap between the first planar side and the second planar side when the first leg portion and the second leg portion are coupled to the anchor.

17. The truss structure of claim 16, wherein for each truss leg, the connecting surface defines one or more holes, and the first leg portion and the second leg portion each define one or more holes at the second end, the one or more holes of the connecting surface configured to align with the one or more holes of each of the first leg portion and the second leg portion.

18. The truss structure of claim 14, wherein each truss leg comprises a connector bracket, the connector bracket of each truss leg configured to couple the top end of the anchor with the first leg portion and the second leg portion.

19. The truss structure of claim 18, wherein the connector bracket of each truss leg comprises a lower portion and an upper portion, the lower portion including a first arm and a second arm configured to couple to a first side and a second side of the anchor at the top end, the upper portion including a planar surface to which the first leg portion and the second leg portion couple.

20. The truss structure of claim 19, wherein the planar surface defines one or more holes, and the first leg portion and the second leg portion each define one or more holes, the one or more holes of the planar surface configured to align with the one or more holes of the first leg portion and the second leg portion when the planar surface is positioned within the gap defined by the first leg portion and the second leg portion.
